(19) United States
(12) Patent Application Publication
(10) Pub. No.: US 2008/0081014 A1
(43) Pub. Date: Apr. 3, 2008

(54) RAPID PREPARATION PROCESS OF AEROGEL

(75) Inventors: Yong-Soo AHN, Yuseong-gu (KR); Jeong-Gu Yeo, Jung-gu (KR); Moon-Hee Han, Seo-gu (KR); Churl-Hee Cho, Seo-gu (KR); Sharad D. Bhagat, Nam-gu (KR); Yong-Ha Kim, Suyeong-gu (KR); Ho-Sung Park, Dongnae-gu (KR)

Correspondence Address: OBLON, SPIVAK, MCCLELLAND MAIER & NEUSTADT, P.C., 1940 DUKE STREET, ALEXANDRIA, VA, 22314, US

(73) Assignee: KOREA INSTITUTE OF ENERGY RESEARCH, Yuseong-gu (KR)

(21) Appl. No.: 11/737,450

(22) Filed: Apr. 19, 2007

(30) Foreign Application Priority Data
Oct. 2, 2006 (KR) 10-2006-0097338

(51) Int. Cl. C01B 33/12

(52) U.S. Cl. 423/338

(57) ABSTRACT

Disclosed herein is a rapid preparation process of aerogel. More specifically, the present invention relates to a rapid preparation process of aerogel which enables a considerable reduction in preparation time and preparation costs via simultaneous treatment of solvent exchange and surface-modification of hydrophilic-to-hydrophobic transition.

The rapid preparation process comprises mixing a cation exchange resin with sodium silicate (water glass) as a starting material, and removing the sodium ion from the sodium silicate, to subject the sodium silicate to ion exchange; adding a base catalyst and an organosilane compound to the sodium silicate to subject the sodium silicate to gelation; aging the gellized silica gel at room temperature for 2 to 4 hours to discharge water from the silica gel and to modify the surface of the silica gel into hydrophobicity; and drying the hydrophobic silica gel at atmospheric pressure for 18 to 27 hours.

### BACKGROUND OF THE INVENTION

1. Field of the Invention

The present invention relates to a rapid preparation process of aerogel. More specifically, the present invention relates to a rapid preparation process of aerogel which enables a considerable reduction in preparation time and preparation costs via simultaneous treatment of solvent exchange and surface-modification in hydrophilic-to-hydrophobic transition.

2. Description of the Related Art

Silica aerogels are known as a solid having a very low density and superior thermal insulating performance owing to their structures in which pores are filled with air. Silica aerogels possess physical properties such as high porosity of 90% or more, large specific surface area of 500 to 1,000 m²/g, and low specific gravity of 0.1 g/cm³.

Conventional synthesis of silica aerogels is based on preparation of alcogels. More specifically, the preparation of silica aerogels is carried out by preparing alcogels from tetramethoxysilane or tetraethoxysilane as silicon precursors, followed by supercritical drying. However, high costs of these precursors and risks involved in the supercritical drying of the alcogels severely restrict commercialization of the aerogels.

As an alternative for the synthesis of silica aerogels, there is a method developed by preparing hydrogels from water glass, followed by ambient drying. However, this method involves aging and drying as well as solvent exchange and surface-modification, thus disadvantageously requiring long preparation time of one week or more. In addition, the method needs to use an organic solvent, such as alcohol (e.g., ethanol, methanol and isopropyl alcohol) or hexane, for replacement of water contained in the hydrogels, thus causing an undesired increase in preparation costs.

The conventional method for preparing aerogels from water glass will be explained in detail with reference to FIG. 3. First, water glass (also termed “sodium silicate”) is subjected to ion exchange. The ion exchange is a process in which the sodium ion of the water glass is exchanged by a hydrogen ion. The resulting water glass is gelled into hydrogel, or hydrophilic gel, via addition of a base, followed by aging at 50° C. for 3 days to reinforce the structure of the water glass. During the aging, the gel undergoes solvent-exchange and surface-modification, thus becoming hydrophobic. The hydrophobic gel was dried at ambient pressure for 3 days, followed by heating at a rate of 1° C./min and a temperature of 230° C. for one hour, to prepare silica aerogel. Accordingly, the method involves a long preparation period of 9 days to complete the aging, surface modification and drying, thus causing high preparation costs and unsuitability for mass-production.

### SUMMARY OF THE INVENTION

In an attempt to solve the problems of prior arts, it is one object of the present invention to provide a method for preparing aerogel capable of realizing a considerable reduction in preparation time which comprises: inducing ion exchange of water glass to prepare a silica solution; adding both trimethyl chlorosilane and hexamethyl disilazane as organosilane compounds to the silica solution to prepare hydrophobic gel; and adding a basic catalyst to the hydrophobic gel to subject the hydrophobic gel to gelation via polymerization, thereby enabling simultaneous treatment of solvent exchange and surface-modification due to the addition of the organosilane compounds prior to sol-gel reaction.

In accordance with an aspect of the present invention for achieving the above object, there is provided a rapid preparation process of aerogel comprising: mixing a cation exchange resin with sodium silicate (water glass) as a starting material, and removing the sodium ion from the sodium silicate, to subject the sodium silicate to ion exchange; adding a base catalyst and an organosilane compound to the sodium silicate to subject the sodium silicate to gelation; aging the silica gel at room temperature for 2 to 4 hours to discharge water from the silica gel and to modify the surface of the silica gel into hydrophobicity; and drying the hydrophobic silica gel at atmospheric pressure for 18 to 27 hours.

Preferably, the sodium silicate may have a concentration of 5 to 10 wt %, the cation exchange resin may be Amberlite IR120H®, and the ratio (v/v) of the cation exchange resin (X) to the water glass (Y) may be X:Y=50-100:100.

Preferably, the organosilane compound may be at least one selected from the group consisting of trimethyl chlorosilane (TMCS), hexamethyl disilazane (HMDS), methyl trimethoxysilane, trimethyl ethoxysilane, ethyl triethoxysilane, and phenyl triethoxysilane.

Preferably, the organosilane compound may be a mixture of trimethyl chlorosilane (TMCS) and hexamethyl disilazane (HMDS), wherein TMCS (X) and HMDS (Y) may be used in a volume ratio of X:Y=100-150:100.

Preferably, the trimethyl chlorosilane (TMCS: X), the hexamethyl disilazane (HMDS: Y), and the silica solution (Z) may be used in a volume ratio of X:Y:Z=2-8:2-10:100.

Preferably, the basic catalyst may be selected from the group consisting of NH₄OH, KOH and NaOH.

The drying may preferably comprise three sub-steps: first drying at 65° C.; second drying at 80° C.; and third drying at 150° C.

Preferably, the first drying, the second drying, and the third drying may be carried out at 65° C. for 15 to 20 hours, at 80° C. for 1 to 3 hours, and at 150° C. for 2 to 4 hours, respectively.

### BRIEF DESCRIPTION OF THE DRAWINGS

The above objects, features and other advantages of the present invention will be more clearly understood from the following detailed description taken in conjunction with the accompanying drawings, in which:

FIG. 1 is a schematic diagram illustrating a process of rapid preparation of aerogel according to one embodiment of the present invention;

FIG. 2 is a graph showing changes in bulk specific gravity of aerogel as a function of the content of trimethyl chlorosilane; and

FIG. 3 is a schematic diagram illustrating a conventional preparation process of aerogel.

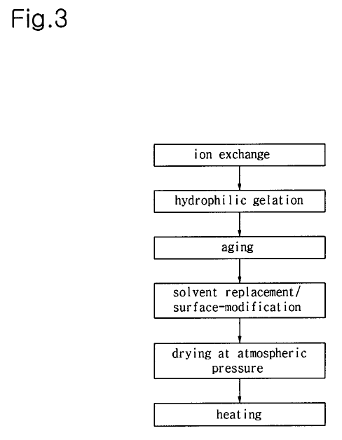

### DETAILED DESCRIPTION OF THE INVENTION

The present invention will now be described in detail with reference to the accompanying drawings.

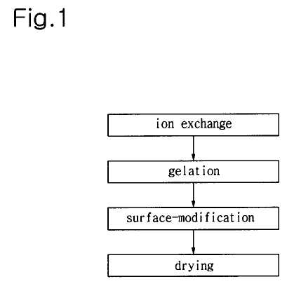

FIG. 1 is a schematic diagram illustrating a rapid preparation process of aerogel according to one embodiment of the present invention.

As shown in FIG. 1, the method of the present invention comprises ion exchange, gelation, surface modification, and drying.

The ion exchange is a process in which the sodium ion of water glass is exchanged for a hydrogen ion via a cation exchange resin added to the water glass. The water glass used herein is where the concentration (i.e., 25 to 30 wt %) of a commercial water glass is adjusted to 5 to 10 wt %. The cation exchange resin used herein is Amberlite IR120H® or Duolite®, both of which are available from Rohm and Haas. The ratio (v/v) of the cation exchange resin (X) to the water glass (Y) is X:Y=50-100:100. The mixture is stirred for 5 to 20 min to complete the ion exchange.

Then, the resulting silica solution is subjected to gelation. The gelation is carried out by adding an organosilane compound for surface modification and a basic catalyst to the silica solution whose solvent is water.

The organosilane compound is at least one selected from group consisting of trimethyl chlorosilane (TMCS), hexamethyl disilazane (HMDS), methyl trimethoxysilane, trimethyl ethoxysilane, ethyl triethoxysilane, and phenyl triethoxysilane. For favorable mixing of the organosilane compound with the silica solution, preferred is use of a combination of trimethyl chlorosilane (TMCS) with hexamethyl disilazane (HMDS).

At this time, TMCS (X) and HMDS (Y) are preferably used in a volume ratio of X:Y=100-150:100. The TMCS (X), HMDS (Y) and the silica solution (Z) are preferably used in a volume ratio of X:Y:Z=2-8:2-10:100.

The organosilane compound consisting of TMCS and HMDS is added to the silica solution, followed by stirring for 1 to 5 min, thereby preparing uniform sol. The mixture in sol state is subjected to gelation by addition of a basic catalyst. The basic catalyst is selected from the group consisting of NH₄OH, KOH and NaOH. To secure uniform mixing, solvent exchange may be carried out via addition of n-hexane prior to the addition of the organosilane compound.

Then, the gellized silica gel is aged at room temperature for 2 to 4 hours to favorably discharge water from the silica gel (i.e., dehydration) and modify the surface of the silica gel into hydrophobicity. That is, the hydrophilic silica polymer reacts with the organosilane compound to replace a water molecule therein with a methyl group. As a result, the silica polymer undergoes surface modification.

The drying comprises three sub-steps of first drying at 65° C., second drying at 80° C., and third drying at 150° C. Each sub-step is carried out at atmospheric pressure. The first drying, the second drying, and the third drying are carried out at 65° C. for 15 to 20 hours, at 80° C. for 1 to 3 hours, and at 150° C. for 2 to 4 hours, respectively. After the overall drying, there can be obtained aerogel in the form of a powder, or a granule with a diameter of 1 to 5 mm.

The separation of the drying into three sub-steps aims to prevent an occurrence of defects, e.g., crack and break, upon drying of hydrophobilized hydrogel. In a case where aerogel is prepared by performing a single drying process at 150° C. for 20 straight hours, the aerogel is readily cracked or broken. The defects are caused by contraction of a silica structure resulting from rapid volatilization of the original solvent from the wetgel. Accordingly, in order to prevent the occurrence of the defects and secure sufficient drying performance, the method of the present invention adopts separate drying of three sub-steps.

The present invention will be better understood from the following examples. These examples are not to be construed as limiting the scope of the invention.

### EXAMPLES

### Example 1

25 mL of 8 wt % water glass solution was prepared from commercial water-glass No. 3 available from Ilsin Chemical Ind. Co., Ltd., KR. The water glass solution was mixed with 25 mL of a cation exchange resin (Amberlite IR120H® available from Rohm and Haas) to exchange a sodium ion of the water glass for a hydrogen ion.

After the mixture was stirred for 10 min, the ion exchange is completed.

The resulting water glass solution was then put into a 100 mL beaker.

The trimethyl chlorosilane and hexamethyl disilazane as organosilane compounds were sequentially added to the water glass solution. The maximum amounts of the trimethyl chlorosilane and hexamethyl disilazane were 1.5 mL and 5 mL, respectively.

After the addition of the two organosilane compounds, the mixture was stirred for 2 min to obtain uniform sol. A NH₄OH solution (13 M) was added to the sol to induce gelation. At this time, the gelation is carried out within 10 min.

After the gellized silica gel was stood at room temperature (e.g., 27° C.) for 3 hours, the water discharged from the silica gel was collected and the amount of the water was measured.

The hydrophobic gel is dried throughout a series of three steps at atmospheric pressure to complete the overall process. At this time, the three drying steps are carried out at 65° C. for 18 hours, at 80° C. for 2 hours, and at 150° C. for 3 hours, respectively.

The aerogel thus prepared was a hydrophobic state in which the aerogel floats on the surface of the water. The hydrophobic state of the aerogel was maintained up to 500° C.

The bulk specific gravity and specific surface area of the aerogel was 0.120 g/cm³ and 505 m²/g, respectively.

### Comparative Example 1

Silica aerogels were prepared in the same manner as Example 1 depending upon variation in the content ratio of hexamethyl disilazane (HMDS) to each silica aerogel as shown in Table 1. The physical properties and chemical properties of each silica aerogel were measured. The results were shown in Table 1 below.

TABLE 1

| | | Bulk specific | Specific surface |
|---|---|---|---|
| HMDS/SA | Pore | gravity (g/cm³) ± | area (m²/g) ± |
| content ratio (H) | of water (%) | 0.002 g/cm³ | 2.0 m²/g |
| 2 × 10⁻² | 18 | 0.135 | 402 |
| 4 × 10⁻² | 32 | 0.118 | — |
| 6 × 10⁻² | 53 | 0.126 | — |
| 8 × 10⁻² | 75 | 0.124 | — |
| 10 × 10⁻² | 80 | 0.120 | 505 |

### Comparative Example 2

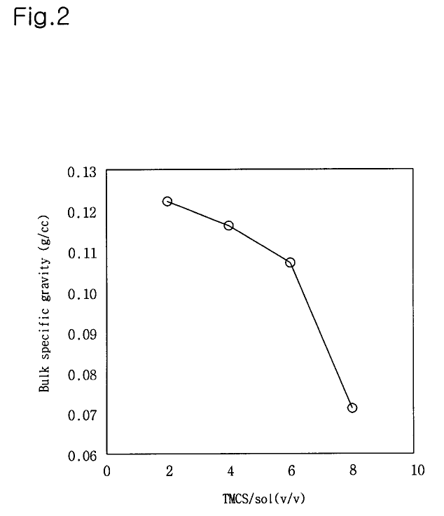

Silica aerogels were prepared in the same manner as Example 1 depending upon variation in the content ratio of trimethyl chlorosilane (TMCS) to each silica aerogel. The bulk density of each silica aerogel was measured. The results were shown in FIG. 2. In FIG. 2, X coordinate is a volume ratio of trimethyl chlorosilane to silicic acid, and Y coordinate is a value of bulk specific gravity.

The silica aerogels thus prepared exhibit superior physical properties such as high porosity, large specific surface area, low dielectric constant, and low sound velocity. Since the silica aerogels show superior thermal insulation performance owing to their considerably low thermal conductivity, they may be widely utilized in pipelines and building insulation applications. In a case where aerogel powders are coated on a window glass to produce a multilayer glass, windows and doors made of the multilayer glass involve a significant reduction in thermal loss, as compared to conventional windows and doors, thereby achieving considerable energy savings.

As apparent from the foregoing, according to the method of the present invention, water glass is subjected to ion exchange to prepare a silica solution, trimethyl chlorosilane and hexamethyl disilazane as organosilane compounds are added to the silica solution to prepare hydrophobic gel, and a basic catalyst is added to the hydrophobic gel to subject the hydrophobic gel to gelation via polymerization. As a result, solvent exchange and surface-modification are simultaneously carried out, thus enabling a considerable reduction in preparation time, mass-production even with limited equipment, and a reduction in preparation costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A rapid preparation process of aerogel comprising:
mixing a cation exchange resin with sodium silicate (water glass) as a starting material, and removing the sodium ion from the sodium silicate, to subject the sodium silicate to ion exchange;
adding a base catalyst and an organosilane compound to the sodium silicate to subject the sodium silicate to gelation;
aging the gellized silica gel at room temperature for 2 to 4 hours to discharge water from the silica gel and to modify the surface of the silica gel into hydrophobicity; and
drying the hydrophobic silica gel at atmospheric pressure for 18 to 27 hours.

2. The rapid preparation process of aerogel according to claim 1, wherein the sodium silicate has a concentration of 5 to 10 wt %, the cation exchange resin is Amberlite IR120H®, and the cation exchange resin (X) and the sodium silicate (Y) is used in a volume ratio of X:Y=50-100:100.

3. The rapid preparation process of aerogel according to claim 1, wherein the organosilane compound is at least one selected from the group consisting of trimethyl chlorosilane (TMCS), hexamethyl disilazane (HMDS), methyl trimethoxysilane, trimethyl ethoxysilane, ethyl triethoxysilane, and phenyl triethoxysilane.

4. The rapid preparation process of aerogel according to claim 3, wherein the organosilane compound is a mixture of trimethyl chlorosilane (TMCS) and hexamethyl disilazane (HMDS),
wherein trimethyl chlorosilane (TMCS; X) and hexamethyl disilazane (HMDS; Y) are used in a volume ratio of X:Y=100-150:100.

5. The rapid preparation process of aerogel according to claim 4, wherein the trimethyl chlorosilane (TMCS: X), the hexamethyl disilazane (HMDS: Y), and the silica solution (Z) are used in a volume ratio of X:Y:Z=2-8:2-10:100.

6. The rapid preparation process of aerogel according to claim 1, wherein the basic catalyst is selected from the group consisting of NH₄OH, KOH and NaOH.

7. The rapid preparation process of aerogel according to claim 1, wherein the drying comprises three sub-steps:
first drying at 65° C.;
second drying at 80° C.; and
third drying at 150° C.

8. The rapid preparation process of aerogel according to claim 7, wherein the first drying, the second drying, and the third drying are carried out at 65° C. for 15 to 20 hours, at 80° C. for 1 to 3 hours, and at 150° C. for 2 to 4 hours, respectively.
